(19) United States
(12) Patent Application Publication
(10) Pub. No.: US 2024/0311052 A1
(43) Pub. Date: Sep. 19, 2024

(54) MEMORY SYSTEM AND CONTROL METHOD

(71) Applicant: Kioxia Corporation, Tokyo (JP)

(72) Inventors: Shinnichirou NAKAZUMI, Kawasaki Kanagawa (JP); Takashi KONDO, Yokohama Kanagawa (JP)

(73) Assignee: Kioxia Corporation, Tokyo (JP)

(21) Appl. No.: 18/594,080

(22) Filed: Mar. 4, 2024

(30) Foreign Application Priority Data
Mar. 17, 2023 (JP) 2023-042999

(51) Int. Cl. G06F 3/06

(52) U.S. Cl. CPC G06F 3/0659; G06F 3/0611; G06F 3/0652; G06F 3/0679

(57) ABSTRACT

A memory system includes: a nonvolatile memory including a cache buffer that can receive second data for a next program operation during execution of a program operation for writing first data to a memory cell array; and a controller. The controller measures an elapsed time from start of the program operation. The controller starts an operation of transferring the second data to the nonvolatile memory according to elapse of a first time from the start of the program operation.

### CROSS-REFERENCE TO RELATED APPLICATION

This application is based upon and claims the benefit of priority from Japanese Patent Application No. 2023-042999, filed Mar. 17, 2023, the entire contents of which are incorporated herein by reference.

### FIELD

Embodiments described herein relate generally to a memory system and a control method for controlling a nonvolatile memory.

### BACKGROUND

In recent years, memory systems including nonvolatile memories have become widespread. As one such memory system, a solid state drive (SSD) including a NAND flash memory is known.

In the memory system such as an SSD, it is required to prevent the increase in the time required from receiving a read command from a host to completing processing of the read command (that is, a read latency). Furthermore, in the memory systems, it is also necessary to improve the performance of writing data to the nonvolatile memory with respect to write commands from the host.

For this reason, in workloads where read commands and write commands are mixed in a command group received from the host, there is a need for a technology that can efficiently write data to a nonvolatile memory while preventing read latency from increasing.

### DESCRIPTION OF THE DRAWINGS

FIG. 1 is a block diagram illustrating a configuration example of an information processing system including a memory system according to at least one embodiment.

FIG. 2 is a block diagram illustrating a configuration example of a nonvolatile memory chip provided in the memory system according to at least one embodiment.

FIG. 3 is a diagram illustrating a configuration example of each of a plurality of blocks provided in the nonvolatile memory chip in the memory system according to at least one embodiment.

FIG. 4 is a diagram illustrating a circuit configuration example of each of the plurality of blocks provided in the nonvolatile memory chip in the memory system according to at least one embodiment.

FIG. 5 is a diagram illustrating a size of a write buffer required in a method of releasing the write buffer according to completion of data transfer to the nonvolatile memory chip and a size of the write buffer required in a method of releasing the write buffer according to a completion of a program operation.

FIG. 6 is a timing chart illustrating an example of a cache program operation executed in the memory system according to at least one embodiment.

FIG. 7 is a timing chart illustrating an example of the cache program operation using a triple-level cell mode, which is executed in the memory system according to at least one embodiment.

FIG. 8 is a timing chart illustrating an example of timing for starting an operation of transferring data for a next program operation to the nonvolatile memory chip in the memory system according to at least one embodiment.

FIG. 9 is a block diagram illustrating a configuration example of each of a plurality of planes provided in the nonvolatile memory chip in the memory system according to at least one embodiment.

FIGS. 10A and 10B are a diagram illustrating a state of the nonvolatile memory chip during execution of a lower page program of a program operation A.

FIGS. 11A and 11B are a diagram illustrating a state of the nonvolatile memory chip during execution of a middle page program of the program operation A.

FIGS. 12A and 12B are a diagram illustrating a state of the nonvolatile memory chip at the start of execution of an upper page program of the program operation A.

FIGS. 13A and 13B are a diagram illustrating an operation of transferring data for a next program operation B to the nonvolatile memory chip during execution of the upper page program operation of the program operation A, which is executed in the memory system according to at least one embodiment.

FIG. 14 is a timing chart illustrating an operation of stopping an operation of a timer while the program operation of the nonvolatile memory chip is suspended, which is executed in the memory system according to at least one embodiment.

FIG. 15 is a flowchart illustrating a first example of a write process procedure executed in the memory system according to at least one embodiment.

FIG. 16 is a flowchart illustrating a second example of the write process procedure executed in the memory system according to at least one embodiment.

FIG. 17 is a flowchart illustrating a third example of the write process procedure executed in the memory system according to at least one embodiment.

### DETAILED DESCRIPTION

Embodiments provide a memory system and a control method capable of efficiently writing data to a nonvolatile memory while preventing read latency from increasing.

In general, according to one embodiment, a memory system includes: a nonvolatile memory including a memory cell array and a cache buffer that can receive second data for a next program operation during execution of a program operation for writing first data to the memory cell array; and a controller configured to control the nonvolatile memory. The controller measures an elapsed time from start of the program operation. The controller starts an operation of transferring the second data to the nonvolatile memory according to elapse of a first time from the start of the program operation so that transfer of the second data to the nonvolatile memory is completed during execution of the program operation and the transfer of the second data to the nonvolatile memory is started after the elapse of the first time from the start of the program operation.

Hereinafter, embodiments will be described with reference to the drawings.

In the following, it is assumed that a memory system according to an embodiment is implemented as a solid state drive (SSD).

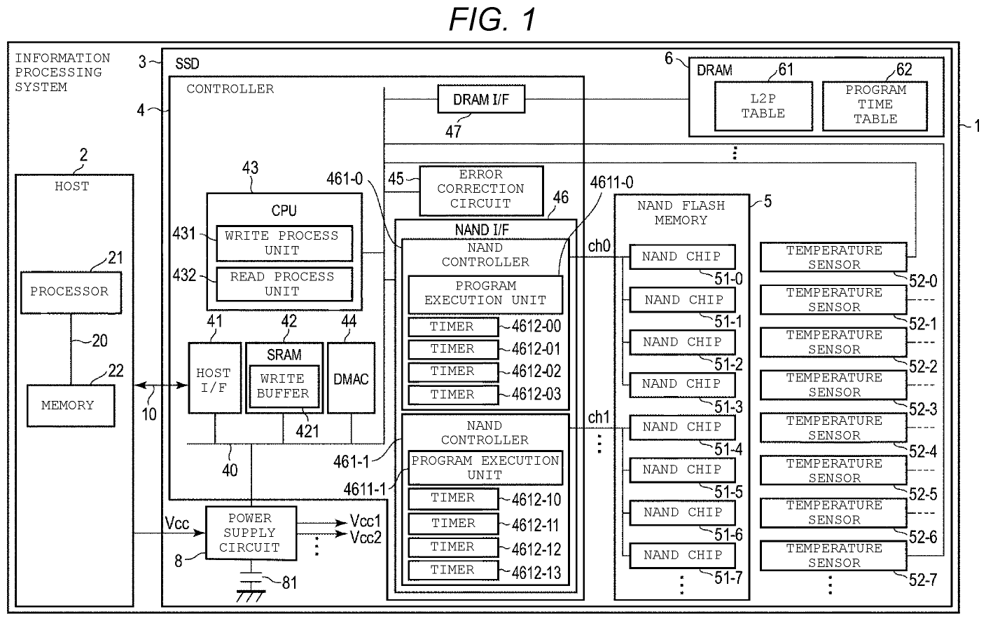

FIG. 1 is a block diagram illustrating a configuration example of an information processing system 1 including the memory system according to the embodiment. The information processing system 1 includes a host (host device) 2 and an SSD 3. The host 2 and the SSD 3 can be connected to each other via a bus 10.

The host 2 is an information processing device. The host 2 is, for example, a personal computer, a server computer, or a mobile device. The host 2 accesses the SSD 3. Specifically, the host 2 transmits a write command, which is a command for writing data, to the SSD 3. Further, the host 2 transmits a read command, which is a command for reading data, to the SSD 3.

The SSD 3 is a storage device connectable to the host 2. The SSD 3 includes a nonvolatile memory.

Communication between the SSD 3 and the host 2 is executed via the bus 10. The bus 10 is a communication path that connects the host 2 and the SSD 3. The bus 10 is, for example, a PCI Express™ (PCIe™) bus. The PCIe bus is a full duplex communication path. The full duplex communication path includes both a transmission path for transmitting data and input/output (I/O) commands from the host 2 to the SSD 3 and a transmission path for transmitting data and responses from the SSD 3 to the host 2. The I/O command is a command for writing data to the nonvolatile memory or reading data from the nonvolatile memory. The I/O command is, for example, a write command or a read command.

As a standard for a logical interface for connecting the host 2 and the SSD 3, for example, an NVM Express™ (NVMe™) standard may be used.

Next, a configuration of the host 2 will be described. The host 2 includes a processor 21 and a memory 22. The processor 21 and the memory 22 are interconnected via an internal bus 20.

The processor 21 is, for example, a central processing unit (CPU). The processor 21 executes software (host software) loaded into the memory 22 from the SSD 3 or other storage device connected to the host 2. The host software includes, for example, an operating system, a file system, and application programs.

The memory 22 is, for example, a volatile memory. The memory 22 is also referred to as a main memory, a system memory, or a host memory. The memory 22 is, for example, a dynamic random access memory (DRAM).

Next, a configuration of the SSD 3 will be described. In the following, it is assumed that the nonvolatile memory of the SSD 3 is implemented by the NAND flash memory.

The SSD 3 includes a controller 4 and a NAND flash memory 5. Further, the SSD 3 may further include a random access memory, for example, a dynamic random access memory (DRAM) 6. Furthermore, the SSD 3 includes a power supply circuit 8 and temperature sensors 52 (52-0, 52-1, 52-2, 52-3, 52-4, 52-5, 52-6, 52-7, . . . ).

The controller 4 is a memory controller. The controller 4 is, for example, a semiconductor device such as a system-on-a-chip (SoC). The controller 4 is electrically connected to the NAND flash memory 5. The controller 4 executes a write process and a read process based on each I/O command received from the host 2. The write process is a process for writing data to the NAND flash memory 5. The read process is a process for reading data from the NAND flash memory 5. As an interface standard for electrically connecting the controller 4 and the NAND flash memory 5, for example, a Toggle interface or an open NAND flash interface (ONFI) is used. Functions of each portion of the controller 4 can be implemented by dedicated hardware, a processor that executes the program, or a combination of these dedicated hardware and the processor.

The NAND flash memory 5 may be a flash memory with a two-dimensional structure or a flash memory with a three-dimensional structure. Hereinafter, the NAND flash memory 5 will be simply referred to as a flash memory 5. The flash memory 5 includes a plurality of blocks. Each of the plurality of blocks is a minimum unit of a data erasing operation. Each of the plurality of blocks includes a plurality of pages. Each of the plurality of pages is a unit of a write operation (specifically, a program operation) and a read operation. The flash memory 5 includes one or more nonvolatile memory chips. The nonvolatile memory chip is, for example, a NAND flash memory chip (hereinafter referred to as a NAND chip). In FIG. 1, a case where the flash memory 5 includes a plurality of NAND chips 51 (51-0 to 51-7, . . . ) is illustrated as an example.

The DRAM 6 is a volatile memory. The DRAM 6 includes a storage area that stores, for example, a logical-to-physical address translation table (L2P table) 61. The DRAM 6 may also include a storage area that stores a program time table 62.

The L2P table 61 is a table that stores mapping information. The mapping information is information indicating the mapping between each logical address and each physical address of the flash memory 5 in units of a predetermined management size. The logical address is an address used by the host 2 to access the SSD 3. For example, a logical block address (LBA) is used as the logical address. The physical address is an address indicating a storage location (physical storage location) in the flash memory 5.

The program time table 62 is a table that stores program time information indicating the correspondence between each program operation condition that causes the program time to change and each program time required for the program operation. The conditions of the program operation that cause the program time to change include, for example, a word line corresponding to a write target page, the number of program/erase cycles of a write target block, or temperature of a write target NAND chip 51.

The power supply circuit 8 is a circuit that supplies power to each component of the SSD 3 (controller 4, flash memory 5, DRAM 6, and the like). The power supply circuit 8 uses, for example, power supplied (herein, power supply voltage Vcc) from the host 2 to generate power (herein, power supply voltages Vcc1, Vcc2, . . . ) to be supplied to each component of the SSD 3.

Temperature sensors 52-0, 52-1, 52-2, 52-3, 52-4, 52-5, 52-6, 52-7, . . . are provided corresponding to NAND chips 51-0, 51-1, 51-2, 51-3, 51-4, 51-5, 51-6, 51-7, . . . . Each temperature sensor 52 detects the temperature of the corresponding NAND chip 51.

It is noted that each of the temperature sensors 52 may be mounted on a printed circuit board of the SSD 3 on which each component of the SSD 3 is mounted. Alternatively, each of the temperature sensors 52 may be embedded into the corresponding NAND chip 51.

Further, in FIG. 1, a case is illustrated in which the plurality of temperature sensors 52 and the plurality of NAND chips 51 are associated with each other in the one-to-one relationship, but these temperature sensors 52 and these the NAND chips 51 may not associated with each other in the one-to-one relationship. For example, the configuration may be used in which one temperature sensor 52 is provided per memory package including several NAND chips 51.

Next, an internal configuration of the controller 4 will be described. The controller 4 includes, for example, a host interface (host I/F) 41, a static RAM (SRAM) 42, a CPU 43, a direct memory access controller (DMAC) 44, an error correction circuit 45, and a NAND interface (NAND I/F) 46, and a DRAM interface (DRAM I/F) 47. The host interface 41, the SRAM 42, the CPU 43, the DMAC 44, the error correction circuit 45, the NAND interface 46, and the DRAM interface 47 are interconnected via an internal bus 40. The controller 4 is configured as an electronic circuit including these components.

The host interface 41 is an interface circuit that executes communication with the host 2. The host interface 41 executes, for example, a process of fetching each I/O command (write command and read command) from the memory 22 of the host 2, a process of acquiring the write data associated with each fetched write command from the memory 22 of the host 2, a process of transferring the data read from the flash memory 5 based on each fetched read command to the memory 22 of the host 2, and a process of transmitting a completion response corresponding to each fetched I/O command to the host 2.

The SRAM 42 is a volatile memory. A storage area of the SRAM 42 is used, for example, as a work area of the CPU 43. A portion of the storage area of the SRAM 42 is used as a write buffer 421. The write buffer 421 is a buffer that temporarily stores the write data received from the host 2. It is noted that a portion of the storage area of the DRAM 6 may be used as the write buffer 421.

The CPU 43 is a processor. The CPU 43 loads the control program (firmware) stored in the flash memory 5 or the ROM (not illustrated) into the SRAM 42. The CPU 43 performs various processes by executing this firmware. It is noted that the firmware may be loaded into the DRAM 6.

The CPU 43 manages the data stored in the flash memory 5 and manages the blocks provided in the flash memory 5, for example, as a flash translation layer (FTL). The management of data stored in the flash memory 5 includes, for example, management of the mapping information. The CPU 43 uses the mapping information of the L2P table 61 to manage the mapping between each logical address and each physical address in units of the predetermined management size.

In the flash memory 5, data can be written to a page in a block only once per program/erase cycle of this block. In other words, a storage location (physical storage location) in a block to which data has already been written cannot be directly overwritten with new data. For this reason, when updating data that has already been written to the physical storage location in the block, the controller 4 writes new data to the unwritten page (empty page) in that block (or other block), and treats the previous data as invalid data. In other words, the controller 4 writes update data corresponding to a certain logical address to other physical storage location rather than to the physical storage location where the previous data corresponding to the logical address is stored. Then, the controller 4 updates the L2P table 61 and associates the logical address with the physical address indicating this other physical storage location.

Management of the blocks provided in the flash memory 5 includes a management of defective blocks (bad blocks) provided in the flash memory 5, a wear leveling, and a garbage collection (GC) (compaction).

The GC is an operation for increasing the number of free blocks. The free block denotes a block that does not contain valid data. The controller 4 manages each block state (whether to be a free block, whether to be an active block, the number of program/erase cycles, the number and position of write-completed pages, the number and position of empty pages, the amount of valid data, the amount of invalid data, or the like). In the GC operation, the controller 4 selects some blocks including a mixture of the valid data and the invalid data as GC source blocks. The GC source block is also referred to as a copy source block. The controller 4 copies the valid data provided in the GC source block to a GC destination block (for example, the free block). The GC destination block is also referred to as a copy destination block. Herein, the valid data denotes data (that is, data associated with the logical address as the latest data) stored in the physical storage location associated with the logical address in the L2P table 61. The valid data is likely to be read from host 2 later. The invalid data denotes data that is not associated with any logical address. The data that is not associated with any logical address is data that is no longer likely to be read by the host 2. When the valid data is copied from the GC source block to the GC destination block, the controller 4 updates the L2P table 61 to map the physical address of the copy destination to each logical address of the copied valid data. The block that contains only the invalid data (no longer contains the valid data) by copying the valid data to other block is released as the free block. Accordingly, this block can be reused for writing data after executing the data erasing operation on this block.

The DMAC 44 is a circuit that executes direct memory access (DMA). The DMAC 44 executes the data transfer between the memory 22 of the host 2 and the SPAM 42 (or the DRAM 6).

The error correction circuit 45 executes encoding processing when data is written to the flash memory 5. In the encoding process, the error correction circuit 45 adds the error correction code (ECC) to the data to be written to the flash memory 5 as a redundant code. When data is read from the flash memory 5, the error correction circuit 45 executes a decoding process. In the decoding process, the error correction circuit 45 uses the ECC added to the data read from the flash memory 5 to detect and correct errors in this data.

The NAND interface 46 is a memory interface circuit that controls the flash memory 5. The NAND interface 46 is connected to the plurality of NAND chips 51 provided in the flash memory 5 via a plurality of channels ch.

Each NAND chip 51 can operate independently. For this reason, the NAND chip 51 functions as a unit that can operate in parallel. The NAND interface 46 includes a plurality of NAND controllers 461 respectively corresponding to the plurality of channels ch. Each of the plurality of NAND controllers 461 is a memory control circuit that controls the NAND chip 51. Each NAND controller 461 controls each NAND chip 51 connected to one corresponding channel ch. In FIG. 1, among the plurality of NAND controllers 461 provided in the NAND interface 46, only the configuration of the two NAND controllers 461-0 and 461-1 connected to the two channels ch0 and ch1, respectively, is illustrated as the representative.

The NAND controller 461-0 is connected to the NAND chips 51-0 to 51-3 via the channel ch0. The NAND controller 461-0 includes a program execution unit 4611-0 and timers 4612-00 to 4612-03 as components that control the program operations.

The program execution unit 4611-0 controls the program operation of each of the NAND chips 51-0 to 51-3 using a cache program function supported by each of the NAND chips 51-0 to 51-3. The cache program function is a function that can receive the write data for the next program operation from the outside during execution of the program operation. The program execution unit 4611-0 transfers the write data for the next program operation to a certain NAND chip while the program operation is being executed on this certain NAND chip. The program operation using the cache program function is referred to as a cache program operation. Details of the cache program operation will be described later.

The timers 4612-00 to 4612-03 are associated with the NAND chips 51-0 to 51-3, respectively. Each of the timers 4612-00 to 4612-03 is used to measure the elapsed time from the start of the program operation in the corresponding the NAND chip 51.

The NAND controller 461-1 is connected to the NAND chips 51-4 to 51-7 via the channel ch1. Like the NAND controller 461-0, the NAND controller 461-1 includes a program execution unit 4611-1 and timers 4612-10 to 4612-13 as components that control the program operation.

The DRAM interface 47 is a circuit that controls the DRAM 6. The DRAM interface 47 stores data in the DRAM 6. Further, the DRAM interface 47 reads data stored in the DRAM 6.

The SSD 3 further includes a capacitor 81. The capacitor 81 is an element or electronic component that can store power. The capacitor 81 is electrically connected to the power supply circuit 8. When the value of the power supply voltage Vcc supplied from the host 2 drops down without advance notice from the host 2, the power supply circuit 8 uses the power stored in the capacitor 81 to supply the power to each component of the SSD 3. The power supply circuit 8 is also connected to the internal bus 40 and notifies the controller 4 (for example, the CPU 43) that an unexpected power loss has occurred. The unexpected power loss is a phenomenon in which the supply of power to the SSD 3 is cut off without advance notice from the host 2 (power cutoff advance notice). The power cutoff advance notice is a notice that announces beforehand the supply of power to the SSD 3 will be turned off (cut off). Before the host 2 is turned off, the host 2 transmits the power cutoff advance notice to the SSD 3 to notify the SSD 3 that the power supply to the SSD 3 will be cut off soon. For example, “shutdown notification” defined in the NVMe standard may be used as the power cutoff advance notice.

Next, a functional configuration of the CPU 43 will be described. The CPU 43 includes a write process unit 431 and a read process unit 432 in addition to components functioning as the FTL. A portion or all of each of the write process unit 431 and the read process unit 432 may be implemented by dedicated hardware of the controller 4.

The write process unit 431 executes a write process by processing each write command received from the host 2. The write process includes, for example, a process of acquiring the write data associated with the write command from the memory 22 of the host 2, a process of writing the write data to the storage location in the flash memory 5, and a process of updating the L2P table 61 to map the physical address indicating the storage location to which the write data is written to the logical address designated by the command. The write process also includes a process of transmitting the completion response indicating completion of the write command process to the host 2. The completion response indicating the completion of the write command process is transmitted to the host 2, for example, according to the transfer of the write data associated with this write command from the memory 22 of the host 2 to the write buffer 421.

In the process of writing the write data to the storage location in the flash memory 5, the NAND interface 46 transfers the write data to the NAND chip 51 and instructs the NAND chip 51 to execute the program operation. The program operation is an operation of writing the write data transferred to the NAND chip 51 to a memory cell array of the NAND chip 51. The program operation is executed by the NAND chip 51.

The read process unit 432 executes the read process by processing each read command received from the host 2. The read process includes a process of reading data corresponding to the logical address designated by the read command from the write buffer 421 or flash memory 5, a process of transferring the read data to the memory 22 of the host 2, and a process of transmitting the completion response indicating the completion of the process of the read command to the host 2. When the write buffer 421 does not have the data corresponding to the logical address designated by the read command, this data is read from the flash memory 5. In this case, the read process unit 432 executes a process of converting the logical address designated by the read command into the physical address by referring to the L2P table 61 and a process of reading data from the storage location in the flash memory 5 (read target NAND chip 51) indicated by the physical address.

In the process of reading data from the storage location in the read target NAND chip 51, the NAND interface 46 instructs the NAND chip 51 to execute the read operation (also referred to as a sense operation). The sense operation is an operation of reading data from the memory cell array of the NAND chip 51. The sense operation is executed in the NAND chip 51. Then, the NAND interface 46 executes a data output operation to transfer the read data from the NAND chip 51 to the controller 4.

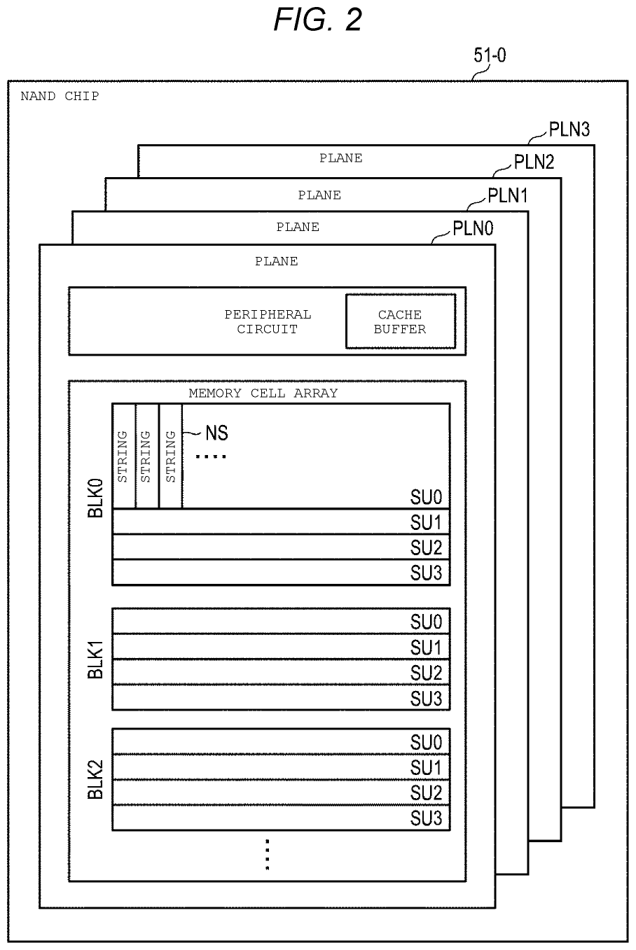

Next, a configuration of the NAND chip 51 will be described. FIG. 2 is a block diagram illustrating a configuration example of the NAND chip 51 provided in the SSD 3.

Herein, the configuration of the NAND chip 51 will be described focusing on the NAND chip 51-0. Other NAND chips 51 also have the same configuration as the NAND chip 51-0. The NAND chip 51-0 includes, for example, a plurality of planes (herein, planes PLN0 to PLN3). Each of the planes PLN0 to PLN3 includes a peripheral circuit and a memory cell array.

The peripheral circuit is a circuit that controls the memory cell array. The peripheral circuit includes, for example, row decoders, column decoders, sense amplifiers, page buffers, and the like. The peripheral circuit executes the program operation, the read operation, or the erasing operation on the memory cell array. The peripheral circuit further includes the cache buffer.

The cache buffer is a buffer that can receive the write data to be used in the next program operation to the memory cell array during execution of the program operation of writing the write data from the page buffer to the memory cell array. The cache program operations are executed by using the cache buffers.

The memory cell array includes a plurality of blocks (BLK0, BLK1, BLK2, . . . ). Each block BLK is a set of nonvolatile memory cell transistors (hereinafter simply referred to as memory cell transistors or memory cells). Each block BLK includes a plurality of string units (SU0, SU1, SU2, and SU3). Each string unit SU is a set of the memory cell transistors. Each string unit SU includes a plurality of NAND strings NS (also simply referred to as strings). Each NAND string NS is a set of the memory cell transistors connected in series.

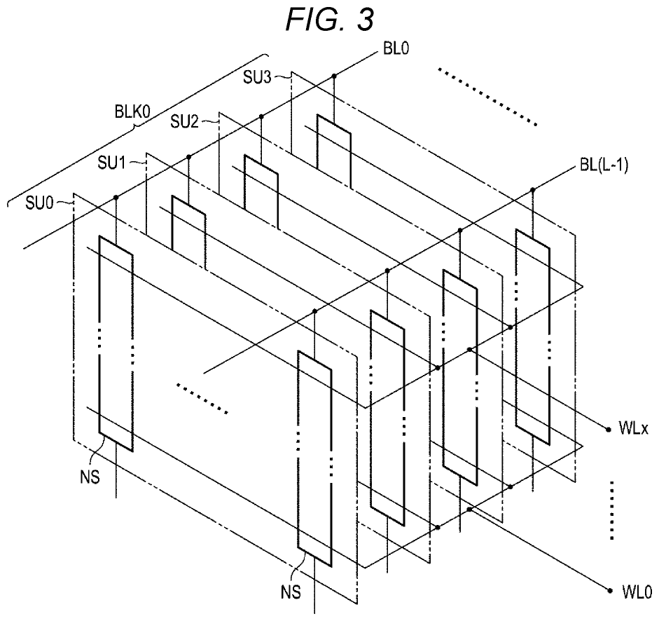

Next, a configuration example of the block BLK will be described. FIG. 3 is a diagram illustrating the configuration example of the block BLK of the flash memory 5 provided in the SSD 3.

In FIG. 3, the configuration of the block BLK will be described focusing on block BLK0. Other blocks BLK also have the same configuration as the block BLK0. The block BLK0 includes four string units (SU0, SU1, SU2, and SU3). The four string units (SU0, SU1, SU2, and SU3) are arranged in the direction (horizontal direction) perpendicular to the direction (vertical direction) in which a plurality of word lines WL0 to WLx are stacked. Each string unit SU includes a plurality of NAND strings NS. One end of each NAND string NS is connected to a corresponding bit line among the plurality of bit lines (BL0 to BL(L−1)). Each NAND string NS extends vertically. Control gates of the plurality of memory cell transistors provided in each NAND string NS are connected to the plurality of word lines (WL0, WL1, . . . , WLx), respectively.

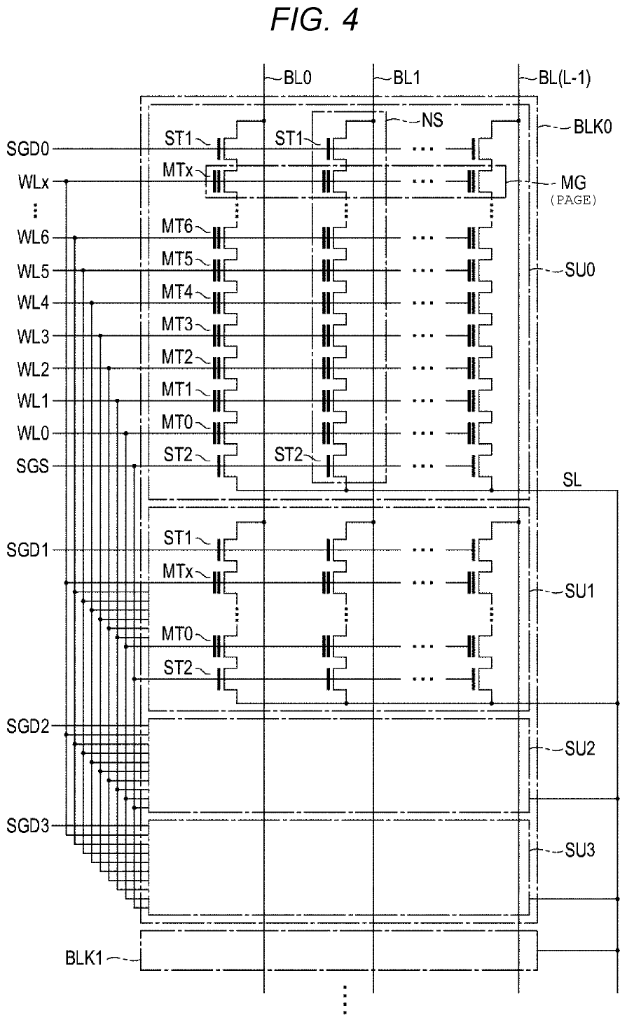

Next, a circuit configuration of the block BLK will be described. FIG. 4 is a diagram illustrating a circuit configuration example of the block BLK of the flash memory 5 provided in the SSD 3.

In FIG. 4, the configuration of the block BLK will be described focusing on block BLK0. Other blocks BLK also have the same configuration as the block BLK0. The block BLK0 includes four string units (SU0, SU1, SU2, and SU3). Each string unit SU includes a plurality of NAND strings NS.

Each NAND string NS includes, for example, a plurality of memory cell transistors MT (MT0 to MTx) and two select transistors ST1 and ST2. Each memory cell transistor MT includes a control gate and a charge storage layer and stores data in a nonvolatile manner. The memory cell transistors MT (MT0 to MTx) are connected in series between the source of the select transistor ST1 and the drain of the select transistor ST2. The drain of the select transistor ST1 is connected to the corresponding bit line BL. The source of the select transistor ST2 is connected to a common source line SL among the string units (SU0, SU1, SU2, and SU3).

The gate of each select transistor ST1 of the string unit SU0 is connected to the select gate line SGD0 corresponding to the string unit SU0. The gate of each select transistor ST1 of the string unit SU1 is connected to the select gate line SGD1 corresponding to the string unit SU1. The gate of each select transistor ST1 of the string unit SU2 is connected to the select gate line SGD2 corresponding to the string unit SU2. The gate of each select transistor ST1 of the string unit SU3 is connected to the select gate line SGD3 corresponding to the string unit SU3. Meanwhile, the gates of the select transistors ST2 of the string units SU0 to SU3 are commonly connected to the select gate line SGS. It is noted that the gates of the select transistors ST2 of the string units SU0 to SU3 may be connected to different select gate lines for the respective string units. Control gates of the memory cell transistors MT0 to MTx in the same block BLK are commonly connected to the word lines WL0 to WLx, respectively.

The program operations and the read operations (sense operations) by the peripheral circuits can be collectively executed on the plurality of memory cells MT connected to one word line WL in one string unit SU. During the program operation and the read operation, a set of memory cells MT collectively selected is referred to as a memory cell group MG (page). When each memory cell MT is configured to store 1-bit data, the size of the data stored per memory cell group MG is called a page size. When each memory cell MT is configured to store 3-bit data, the size of the data stored per memory cell group MG is 3-page size.

The erasing operation by the peripheral circuit is executed in units of the blocks BLK. That is, data stored in all memory cells MT provided in one block BLK is collectively erased.

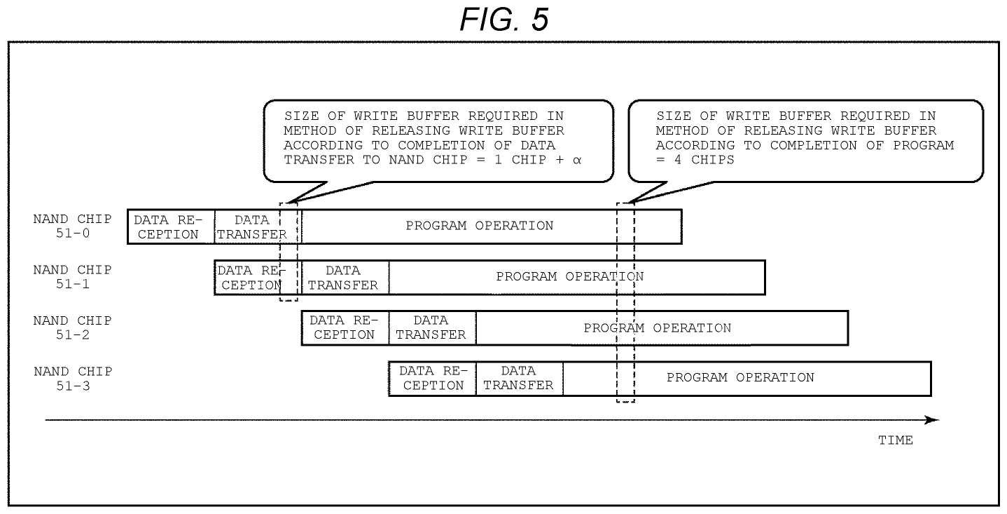

Next, a release operation of the write buffer 421 in the SSD 3 will be described. FIG. 5 is a diagram illustrating a size of the write buffer 421 required in a method of releasing the write buffer 421 according to completion of data transfer to the NAND chip 51 and a size of the write buffer 421 required in a method of releasing the write buffer 421 according to the completion of the program operation.

In FIG. 5, the lengths of “data reception”, “data transfer”, and “program operation” with respect to the elapse of time correspond to the time required for each operation. The “data reception” indicates the data transfer time required to transfer the write data from the host 2 to the write buffer 421 of the SSD 3. The “data transfer” indicates the data transfer time required to transfer the write data from the write buffer 421 to the NAND chip 51. The “program operation” indicates the program time required for the program operation of writing the write data from the page buffer of the peripheral circuit of the NAND chip 51 to the memory cell array.

The NAND chips 51-0 to 51-3 can operate independently of each other. However, when the NAND chips 51-0 to 51-3 share the same channel ch0, the transfer of the write data to the NAND chips 51-0 to 51-3 cannot be simultaneously executed. For this reason, the transfer of the write data to the NAND chips 51-0 to 51-3 connected to the same channel ch0 is executed in a time division manner (interleaved manner) so that the transfer of the write data to other NAND chips 51 during execution of the program operation of a certain NAND chip 51 is executed.

In this embodiment, according to the completion of the transfer of the write data from the write buffer 421 to the NAND chip 51, the controller 4 executes the process of releasing an area in the write buffer 421 where the write data is stored. The write buffer 421 may be released, for example, in units of the predetermined data size smaller than the size of the write data. The released area in the write buffer 421 is available for storing other write data received from the host 2.

When the method is used in which the write buffer 421 is released according to the completion of data transfer to the NAND chip 51, the size of the write buffer 421 required per channel is a size of one chip+α. Herein, the size for one chip is a size of the write data to be written to the memory cell array in the program operation of the NAND chip 51. For example, in a case where the page size is 16 KB and data is written to the four planes simultaneously using a triple level cell (TLC) mode, in which 3-bit data is written per to memory cell, the size of one chip is 192 KB (=(16 KB×3 pages×4 planes). α is a size necessary to allow all of the next write data from the host 2 to be stored in the write buffer 421 at the time when all of the write data have been transferred from the write buffer 421 to the NAND chip 51. When releasing the write buffer 421 in units of the predetermined data size smaller than the size of the write data, α is a size smaller than the size of one chip.

On the other hand, when the method is used in which the area in the write buffer 421 in which the write data is stored is released according to completion of the program operation of the write data, the size of the write buffer 421 that needs to be installed in the SSD 3 per channel is a size of several chips per channel, for example, a size of 4 chips.

In this manner, when the method is used in which the write buffer 421 is released according to completion of the data transfer to the NAND chip 51, since the size of the write buffer 421 required to be installed in the SSD 3 is reduced, there is an advantage of cost reduction. Specifically, costs can be reduced by reducing the size of the RAM itself used as the write buffer 421. Furthermore, by reducing the amount of data in the write buffer 421 that needs to be rendered nonvolatile when the unexpected power loss occurs, the capacity of the capacitor 81 required to be mounted in the SSD 3 can also be reduced.

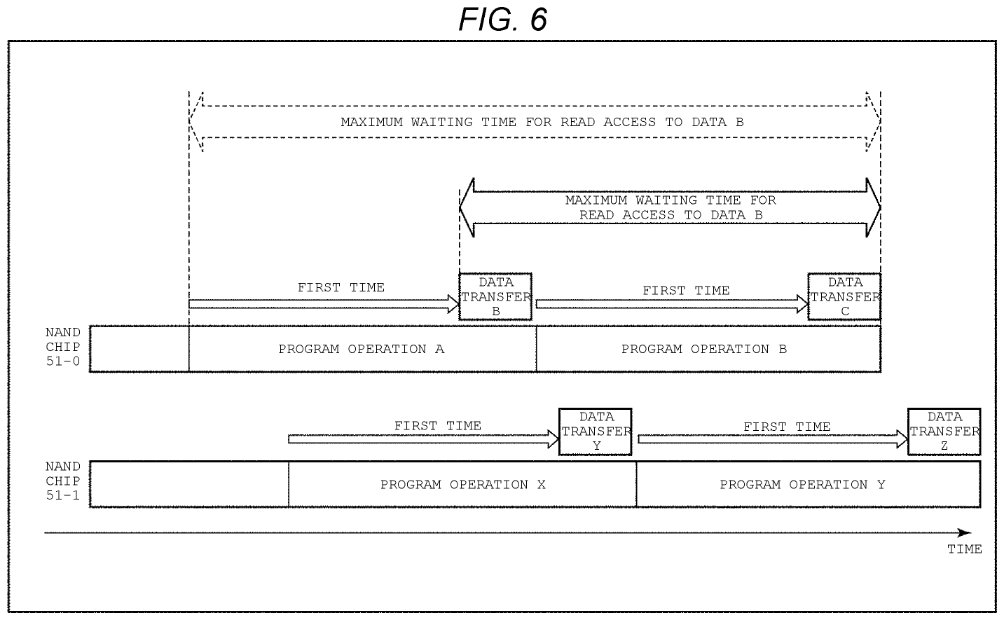

Next, an example of the cache program operation will be described. FIG. 6 is a timing chart illustrating an example of the cache program operation executed in the SSD 3.

In FIG. 6, the case is assumed in which the NAND chip 51-0 is caused to execute a program operation A and a next program operation B, and the NAND chip 51-1 is caused to execute a program operation X and a next program operation Y.

When using the cache program function of the NAND chip 51-0, the NAND controller 461-0 can execute the data transfer (“data transfer B”) of the write data B for the next program operation B to the NAND chip 51-0, during execution of the program operation A on the NAND chip 51-0.

In this embodiment, the start timing of the “data transfer B” is controlled so that the transfer of the write data B is started after the first time has elapsed from the start of the program operation A and the transfer of the write data B to the NAND chip 51-0 is completed during execution of the program operation A.

The first time is a time determined based on the “program time” and the “data transfer time.” The “program time” is a time required to execute the program operation A in the NAND chip 51-0. The “data transfer time” is a time required for the “data transfer B” to the NAND chip 51-0.

At the start of the program operation A, the NAND controller 461-0 starts the operation of the timer 4612-00 corresponding to the NAND chip 51-0. Then, when the elapsed time measured by the timer 4612-00 reaches the first time, the NAND controller 461-0 starts the “data transfer B”.

Accordingly, the start timing of the “data transfer B” can be controlled so that the “data transfer B” can be completed during execution of the program operation A and the “data transfer B” can be started as late as possible. At the time when the program operation A is completed, the “data transfer B” is also completed. For this reason, when the program operation A is completed, the NAND chip 51-0 can start the program operation B.

During execution of the program operation B in the NAND chip 51-0, the NAND controller 461-0 can execute the data transfer (“data transfer C”) of the write data C for a next program operation C to the NAND chip 51-0.

In this embodiment, “data transfer C” is also executed after elapse of the first time from the start of the program operation B. That is, the NAND controller 461-0 also starts the operation of the timer 4612-00 corresponding to the NAND chip 51-0 at the start of the program operation B in the NAND chip 51-0. Then, when the elapsed time measured by the timer 4612-00 reaches the first time, the NAND controller 461-0 starts “data transfer C”. The program time required for the program operation B is approximately the same as the program time required for the program operation A. Further, the data transfer time required for the data transfer C is the same as the data transfer time required for the data transfer B.

In this manner, by using the cache program function of the NAND chip 51-0, the write data for the next program operation can be transferred to the NAND chip 51-0 during execution of the program operation in the NAND chip 51-0. Therefore, data transfer time can be hidden within the program time. As a result, the performance of writing data to the NAND chip 51-0 is improved compared to a case where the transfer of the write data for the next program operation to the NAND chip 51-0 is started after the program operation in the NAND chip 51-0 is completed.

Furthermore, in this embodiment, since the start timing of the “data transfer B” is controlled to be as late as possible within the range where the cache program function can be effectively used, the maximum waiting time for the read access to the data B can be shortened.

In this embodiment, the maximum waiting time for the read access to the data B is a time from the start of the “data transfer B” to the completion of the program operation B, as illustrated by the solid block arrow in FIG. 6. Accordingly, the read latency can be reduced compared to a case where the “data transfer B” is started at the start of the program operation A. The reason why the read latency can be shortened is as follows.

When the write data is transferred to the NAND chip 51-0, this write data is discarded from the write buffer 421.

Immediately after the data is transferred from the write buffer 421 to the NAND chip 51-0, the read command designating the LBA of this data may be received from the host 2. In this case, the latest data corresponding to this LBA no longer exists in the write buffer 421. For this reason, in order to read the latest data corresponding to this LBA, it is necessary to wait until the program operation of this data is completed. Therefore, the maximum waiting time for the read access to the data B is a time from the start of the “data transfer B” to the completion of the program operation B.

The “data transfer B” to the NAND chip 51-0 can also be started when the program operation A is started. However, in this case, the maximum waiting time for the read access to the data B is a time from the start of the program operation A to the completion of the program operation B, as illustrated by the broken line block arrow in FIG. 6. This time is approximately twice as long as the waiting time in this embodiment.

The first time is determined based on a remaining time obtained by subtracting the data transfer time required to transfer the write data for the program operation B from the program time required to execute the program operation A, that is, ([program time]−[data transfer time]).

When the first time is set to ([program time]−[data transfer time]), the timing at which the “data transfer B” is started can be set to be the latest timing within a range in which the data transfer of the write data for the program operation B can be completed during execution of the program operation A.

It is noted that the transfer of the write data to each NAND chip 51 is executed by transmitting a predetermined command sequence (for example, a command sequence including a first command, an address, write data, and a second command) to each NAND chip 51. Most of the time required to transmit this command sequence is a data transfer time required to transfer the write data. For this reason, when determining the first time, it is sufficient to take the “data transfer time” into consideration.

The “data transfer Y” and the “data transfer Z” to the NAND chip 51-1 are also controlled in the same manner as the “data transfer A” and the “data transfer B” to the NAND chip 51-0.

In this case, the timing to start the “data transfer Y” and the “data transfer Z” to the NAND chip 51-1 is controlled by using the timer 4612-01 corresponding to the NAND chip 51-1.

That is, the NAND controller 461-0 starts the operation of the timer 4612-01 corresponding to the NAND chip 51-1 at the start of the program operation X in the NAND chip 51-1. Then, when the elapsed time measured by the timer 4612-01 reaches the first time, the NAND controller 461-0 starts the “data transfer Y”. Further, the NAND controller 461-0 also starts the operation of the timer 4612-01 corresponding to the NAND chip 51-1 at the start of the program operation Y in the NAND chip 51-1. Then, when the elapsed time measured by the timer 4612-01 reaches the first time, the NAND controller 461-0 starts the “data transfer Z”.

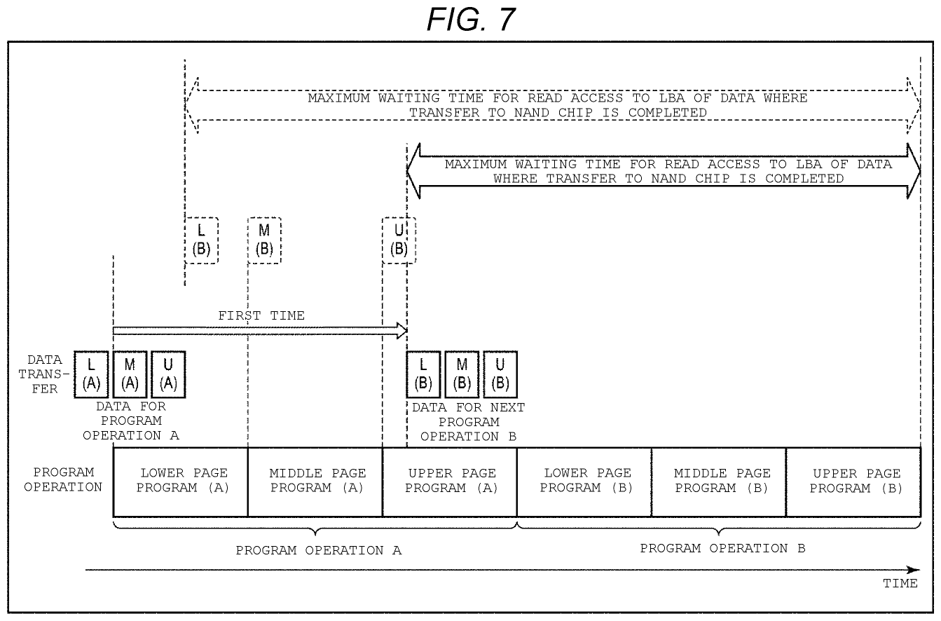

Next, other example of the cache program operation will be described. FIG. 7 is a timing chart illustrating an example of a cache program operation using the TLC mode.

When the certain the NAND chip 51 executes the program operation of the TLC mode, three pages of the write data (lower page data, middle page data, and upper page data) are transferred from the write buffer 421 to the NAND chip 51. The program operation A executed in the NAND chip 51 is executed by a lower page program, a middle page program, and an upper page program. In the lower page program, the operation of writing the lower page data from the page buffer for the lower page of the NAND chip 51 to the memory cell array is executed. In the middle page program, the operation of writing middle page data from the page buffer for the middle page of the NAND chip 51 to the memory cell array is executed. In the upper page program, the operation of writing the upper page data from the page buffer for the upper page of the NAND chip 51 to the memory cell array is executed.

First, the controller 4 transfers the lower page data L(A) for the program operation A, the middle page data M(A) for the program operation A, and the upper page data U(A) for the program operation A from the write buffer 421 to the NAND chip 51.

The transfer of the lower page data L(A) to the NAND chip 51 is executed, for example, by transmitting the command sequence for the lower page program to the NAND chip 51. The command sequence for the lower page program includes, for example, the first command, the address ADDR, the write data DATA, and the second command. The first command includes, for example, a command code that designates the lower page program, and a command code for declaring that the address ADDR indicating a write target storage area is to be input from now on. The address ADDR includes, for example, the block address indicating the write target block and the page address indicating the write target page. It is noted that, when the NAND chip 51 includes a plurality of the planes, the address ADDR may further include the address (plane address) that designates a write target plane. The write data DATA is, for example, the lower page data having a size equal to the page size.

The transfer of the middle page data M(A) to the NAND chip 51 is executed by transmitting the command sequence for the middle page program to the NAND chip 51. The difference between the command sequence for the middle page program and the command sequence for the lower page program is that the first command of the command sequence for the middle page program includes the command code designating the middle page program and the write data DATA of the command sequence for the middle page program is the middle page data. In other respects, the command sequence for the middle page program is the same as the command sequence for the lower page program.

The transfer of the upper page data U(A) to the NAND chip 51 is executed by transmitting the command sequence for the upper page program to the NAND chip 51. The difference between the command sequence for the upper page program and the command sequence for the lower page program is that the first command of the command sequence for the upper page program includes the command code designating the upper page program and the write data DATA of the command sequence for the upper page data is the upper page data. In other respects, the command sequence for the upper page program is the same as the command sequence for the lower page program.

When the lower page data L(A) is transferred to the NAND chip 51, that is, when the reception of the command sequence for the lower page program is completed, the NAND chip 51 starts the lower page program of the program operation A. The lower page program is an operation of writing the lower page data L(A) from the page buffer for the lower page to the memory cell array.

When the lower page program is completed, the NAND chip 51 starts the middle page program of the program operation A. The middle page program is an operation of writing the middle page data M(A) from the page buffer for the middle page to the memory cell array.

When the middle page program is completed, the NAND chip 51 starts the upper page program of the program operation A. The upper page program is an operation of writing the upper page data U(A) from the page buffer for the upper page to the memory cell array.

In this embodiment, the transfer of three pages of the write data (lower page data L(B), middle page data M(B), and upper page data U(B)) for the next program operation B to the NAND chip 51 are executed so that the transfer of three pages of the write data for the program operation A to the NAND chip 51 is completed during execution of the program operation A, and the transfer of three pages of the write data to the NAND chip 51 is started after the first time has elapsed from the start of the lower page program of the program operation A.

The first time is a time determined based on the program time required to execute the program operation A and the data transfer time required for the data transfer of the write data (lower page data L(B), middle page data M(B), and upper page data U(B)) for the program operation B. Accordingly, the start timing of the transfer of three pages of the write data (L(B), M(B), and U(B)) can be controlled so that, for example, the transfer of three pages of the write data (L(B), M(B), and U(B)) is completed, during execution of the program operation A, and the transfer of three pages of the write data (L(B), M(B), and U(B)) is started at the latest possible timing.

The first time is determined based on the remaining time obtained by subtracting the data transfer time required to transfer three pages of the write data for the program operation B from the program time for three pages required to execute the program operation A, that is, ([program time]−[data transfer time]).

When the first time is set to ([program time]−[data transfer time]), the timing at which the data transfer of three pages of the write data for the program operation B is started can be set to be the latest timing within a range in which the data transfer of the write data for the program operation B can be completed during execution of the program operation A. In this case, as illustrated in the figure, the lower page data L(B) for the program operation B, the middle page data M(B) for the program operation B, and the upper page data U(B) for the program operation B are transferred to the NAND chip 51 during execution of, for example, the upper page program of the program operation A.

The transfer of the lower page data L(B) for the program operation B to the NAND chip 51 is executed by transmitting the above-described command sequence for the lower page program to the NAND chip 51. The transfer of the middle page data U(B) for the program operation B to the NAND chip 51 is executed by transmitting the above-described command sequence for the middle page program to the NAND chip 51. Similarly, the transfer of the upper page data U(B) for the program operation B to the NAND chip 51 is executed by transmitting the above-described command sequence for the upper page program to the NAND chip 51.

When the upper page program of the program operation A is completed, the NAND chip 51 starts the lower page program of the program operation B which writes the lower page data L(B) from the page buffer for the lower page to the memory cell array.

When the lower page program is completed, the NAND chip 51 starts the middle page program of the program operation B which writes the middle page data M(B) from the page buffer for the middle page to the memory cell array.

When the middle page program is completed, the NAND chip 51 starts the upper page program of the program operation B which writes the upper page data U(B) from the page buffer for the upper page to the memory cell array.

Each of the program operations A and B may be executed by using a programming method of allowing the lower page data to be read after completion of an upper program.

In this case, the maximum waiting time for the read access to the lower page data L(B) for the program operation B is a time from the start of data transfer of the lower page data L(B) until the upper page program of the program operation B is completed, as illustrated by the solid block arrow in FIG. 7.

The probability of occurrence of a situation in which immediately after data to be written is transferred to the NAND chip 51 a read command designating the LBA for this data is received from the host 2 is a low probability of about (16 KB×3 pages)/(drive capacity) (several TB) under the assumption that the address designated in the read access from the host 2 is random. However, reducing the read latency in such a situation is advantageous in that the worst read latency can be reduced. The host 2 such as a server tends to regard the worst read latency as important. For this reason, the configuration of the storage that can reduce the worst read latency is useful for the host 2 such as the server.

The transfer of the lower page data L(B) for the program operation B to the NAND chip 51 may start immediately after the transfer of the upper page data U(A) for the program operation A is completed, as illustrated by the broken line.

However, in this case, the maximum waiting time for the read access to the lower page data L(B) for the program operation B, that is, the worst latency for reading will take about twice as long as the waiting time in this embodiment as illustrated by the broken block arrow.

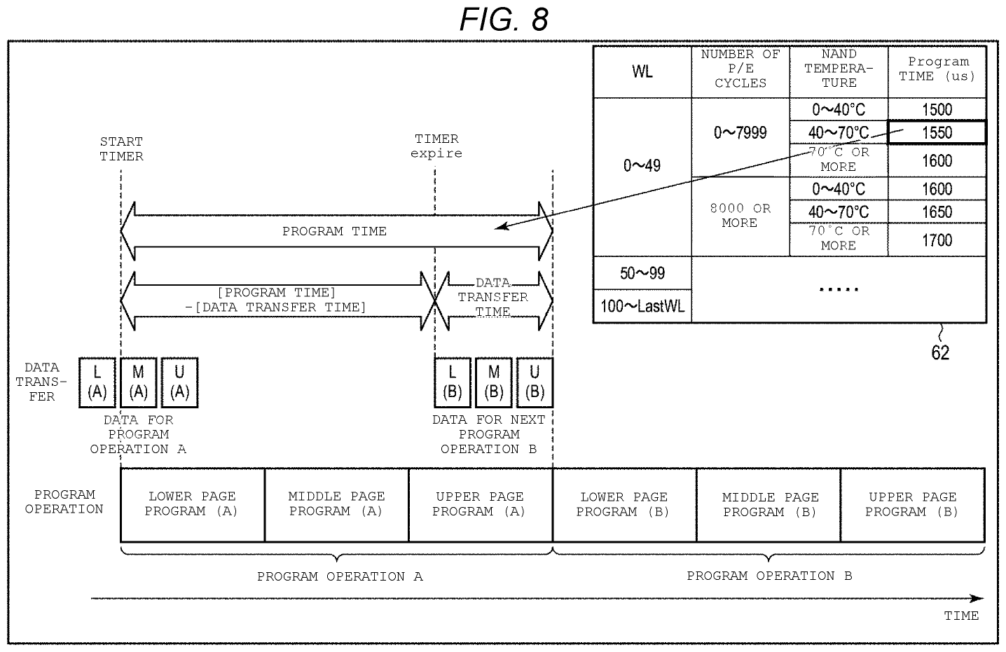

Next, the control of the data transfer timing will be described. FIG. 8 is a timing chart illustrating an example of the timing for starting an operation of transferring the data for the next program operation to the flash memory 5 (NAND chip 51).

For example, when causing the NAND chip 51-0 to execute the program operation A, the NAND controller 461 sets the first time ([program time]−[data transfer time]) to the timer 4612-00 corresponding to the NAND chip 51-0. The NAND controller 461 sequentially transmits the command sequence for the lower page program, the command sequence for the middle page program, and the command sequence for the upper page program to the NAND chip 51-0.

When the program operation A is started in the NAND chip 51-0, that is, when the transfer of the command sequence for the lower page program to the NAND chip 51-0 is completed, the NAND controller 461 starts the operation of the timer 4612-00 corresponding to the NAND chip 51-0.

When the first time has elapsed from the start of the program operation A (start of the lower page program of the program operation A), the timer 4612-00 notifies the NAND controller 461 of the occurrence of timeout (expire).

When receiving this notification from the timer 4612-00, the NAND controller 461 detects that the first time has elapsed from the start of the program operation A of the NAND chip 51-0. Then, according to this detection, the NAND controller 461 starts the data transfer of the write data (lower page data L(B), middle page data M(B), and upper page data U(B) for the program operation B to the NAND chip 51-0). In this case, the NAND controller 461 sequentially transmits the command sequence for the lower page program, the command sequence for the middle page program, and the command sequence for the upper page program to the NAND chip 51-0.

In some cases, the program time changes depending on conditions such as a degree of wear of the write target block (the number of program/erase cycles), the temperature of the write target NAND chip 51 (in this case, the NAND chip 51-0), and which word line is to be programmed. For this reason, before causing the NAND chip 51-0 to execute the program operation A, the NAND controller 461 of the controller 4 acquires the program time corresponding to the current conditions related to the program operation A from the program time table 62, and assumes that the acquired program time is a program time required for the program operation A.

More specifically, the NAND controller 461 acquires the program time corresponding to the current conditions related to the program operation A from the program time table 62 based on i) the current number of program/erase cycles of the block on which the program operation A is to be executed, ii) the current temperature of the NAND chip 51 (herein, the NAND chip 51-0) on which the program operation A is to be executed, or iii) which word line WL of the plurality of word lines WL corresponds to the page on which the program operation A is to be executed. The current temperature of the NAND chip 51 is a value obtained based on the output signal of the temperature sensor 52 corresponding to the NAND chip 51.

Then, the NAND controller 461 applies the acquired program time to [program time] of the first time ([program time]−[data transfer time]) to obtain the first time.

For example, when the word line WL connected to the page on which the program operation A is to be executed is WL1, when the current number of program/erase cycles of the block on which the program operation A is to be executed is 1000, and when the temperature of the NAND chip 51 on which the program operation A is to be executed is 50° C., 1550 us is acquired from the program time table 62. Since the [data transfer time] is known, the NAND controller 461 sets the remaining time obtained by subtracting the [data transfer time] from 1550 us to the timer as the first time.

In this manner, a program time corresponding to a combination of the plurality of conditions related to the plurality of parameters (word line, the number of program/erase cycles, temperature of the NAND chip) that cause the program time to change is acquired from the program time table 62, thereby, the first time can be obtained with high accuracy. It is noted that, although the case has been described here in which the program time corresponding to the combination of the current conditions related to each of the plurality of parameters (word line, the number of program/erase cycles, temperature of the NAND chip) is acquired from the program time table 62, a configuration may also be used in which the program time corresponding to the current condition related to one of the parameters is acquired from the program time table 62.

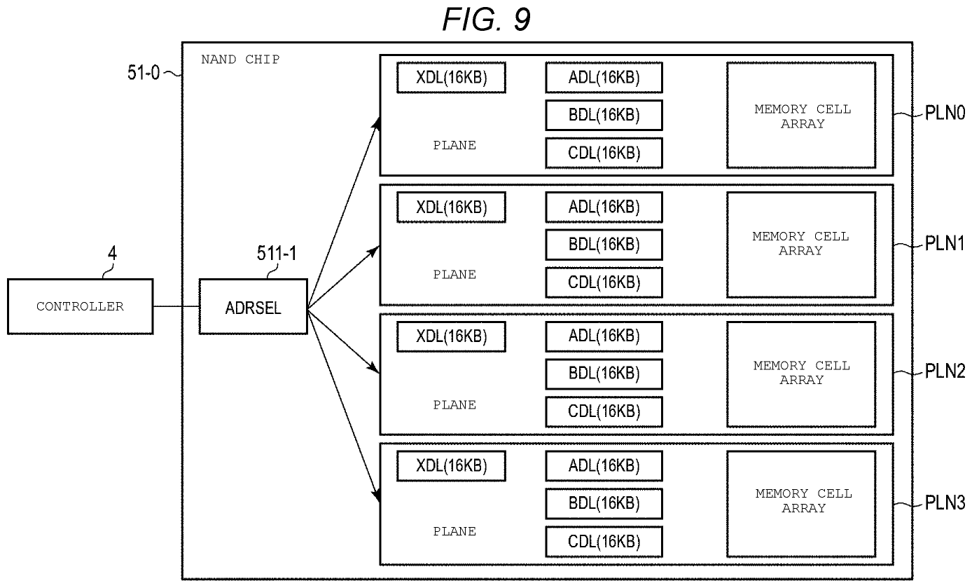

Next, an example of a method of using the cache buffer provided in each plane PLN will be described. FIG. 9 is a block diagram illustrating a configuration example of each of the plurality of planes PLN provided in the NAND chip 51.

Herein, the configuration of each plane PLN will be described focusing on the NAND chip 51-0. The NAND chip 51-0 includes an address selector (ADRSEL) 511-1 in addition to the planes PLN0 to PLN3. The address selector (ADRSEL) 511-1 is a circuit that selects one of the planes PLN0 to PLN3 based on the plane address included in the address ADDR of the command sequence received from the controller 4.

Each of the planes PLN0 to PLN3 includes three page buffers in addition to the memory cell array. The three page buffers are called ADL, BDL, and CDL, respectively.

The ADL is a page buffer for storing the lower page data. The BDL is a page buffer for storing middle page data. The CDL is a page buffer for storing the upper page data. Each of the ADL, the BDL, and the CDL has a size of one page (16 KB).

Each of the planes PLN0 to PLN3 has a cache buffer called XDL in addition to ADL, BDL, and CDL. The XDL has a size of one page (16 KB).

In the following, the cache program operation when writing data to the planes PLN0 to PLN3 at the same time will be described.

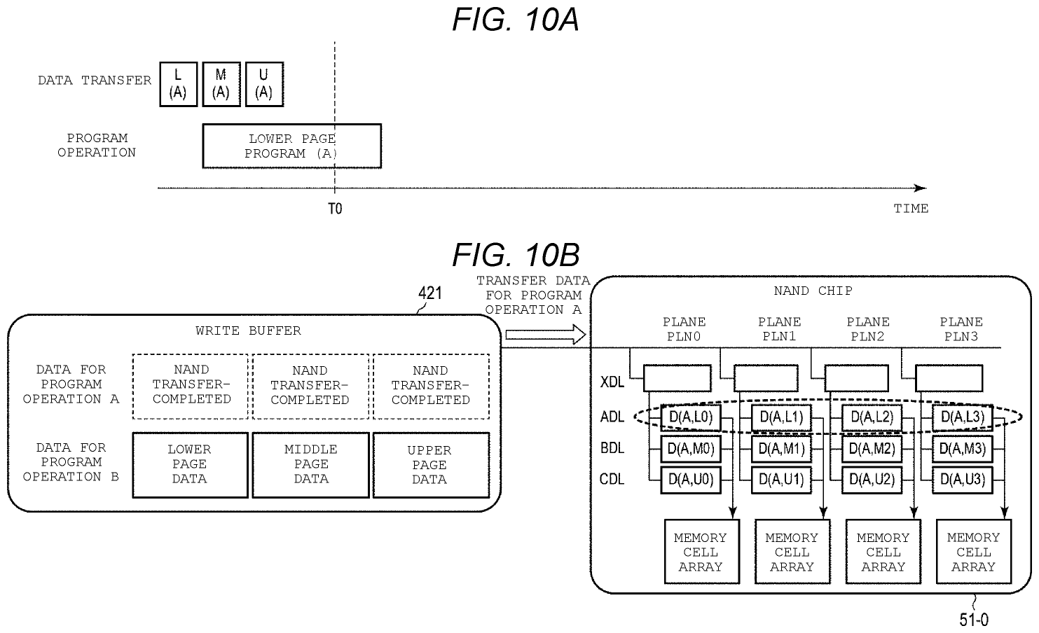

FIG. 10 is a diagram illustrating a state of the NAND chip 51-0 during execution of the lower page program of the program operation A.

As illustrated in FIG. 10A, at timing TO, the transfer of the write data for the program operation A (lower page data L(A), middle page data M(A), and upper page data U(A)) has already been completed, and the lower page program of the program operation A is being executed in the NAND chip 51-0.

The lower page data L(A) has a size of 64 KB (=16 KB×4 planes). The lower page data L(A) includes data D(A, L0), data D(A, L1), data D(A, L2), and data D(A, L3). The data D(A, L0) is the 16 KB lower page data to be written to the plane PLN0. The data D(A, L1) is the 16 KB lower page data to be written to the plane PLN1. The data D(A, L2) is the 16 KB lower page data to be written to the plane PLN2. The data D(A, L3) is the 16 KB lower page data to be written to the plane PLN3.

As illustrated in FIG. 10B, the data D(A, L0), the data D(A, L1), the data D(A, L2), and the data D(A, L3) are stored in the ADL of the plane PLN0, the ADL of the plane PLN1, the ADL of the plane PLN2, and the ADL of the plane PLN3, respectively.

The middle page data M(A) also has a size of 64 KB (=16 KB×4 planes). The middle page data M(A) includes data D(A, M0), data D(A, M1), data D(A, M2), and data D(A, M3). The data D(A, M0) is 16 KB middle page data to be written to the plane PLN0. The data D(A, M1) is 16 KB middle page data to be written to the plane PLN1. The data D(A, M2) is 16 KB middle page data to be written to the plane PLN2. The data D(A, M3) is 16 KB middle page data to be written to the plane PLN3.

As illustrated in FIG. 10B, the data D(A, M0), the data D(A, M1), the data D(A, M2), and the data D(A, M3) are stored in the BDL of the plane PLN0, the BDL of the plane PLN1, the BDL of the plane PLN2, and the BDL of the plane PLN3, respectively.

The upper page data U(A) also has a size of 64 KB (=16 KB×4 planes). The upper page data U(A) includes data D(A, U0), data D(A, U1), data D(A, U2), and data D(A, U3). The data D(A, U0) is the 16 KB upper page data to be written to the plane PLN0. The data D(A, U1) is the 16 KB of the upper page data to be written to the plane PLN1. The data D(A, U2) is the 16 KB upper page data to be written to the plane PLN2. The data D(A, U3) is the 16 KB upper page data to be written to the plane PLN3.

As illustrated in FIG. 10B, the data D(A, U0), the data D(A, U1), the data D(A, U2), and the data D(A, U3) are stored in the CDL of the plane PLN0, the CDL of the plane PLN1, the CDL of the plane PLN2, and the CDL of the plane PLN3, respectively.

It is noted that, when transferring the lower page data L(A) to the NAND chip 51-0, the NAND controller 461 sequentially transmits the command sequence for the lower page program of the plane PLN0, the command sequence for the lower page program of the plane PLN1, and the command sequence for the lower page program of the plane PLN2, and the command sequence for the lower page program of PLN3 to the NAND chip 51-0. The address ADDR of the command sequence for the lower page program of the plane PLN0 includes a plane address that designates the plane PLN0. For this reason, the NAND chip 51-0 that has received this command sequence stores the data D(A, L0) included as the write data DATA in this command sequence in the ADL of the plane PLN0 via the XDL of the plane PLN0. Each address ADDR of the command sequence for the lower page program of the plane PLN1, the command sequence for the lower page program of the plane PLN2, and the command sequence for the lower page program of the plane PLN3 also includes a plane address that designates the corresponding plane. Therefore, the data D(A, L1) is stored in the ADL of the plane PLN1 via the XDL of the plane PLN1, the data D(A, L2) is stored in the ADL of the plane PLN2 via the XDL of the plane PLN2, and the data D(A, L3) is stored in the ADL of the plane PLN3 via the XDL of the plane PLN3.

The transfer of each of the middle page data M(A) and the upper page data U(A) to the NAND chip 51-0 is executed in the same manner as the lower data L(A).

When the transfer of the lower page data L(A) to the NAND chip 51-0 is completed, the NAND chip 51-0 simultaneously executes the lower page program for writing the data D(A, L0) to the memory cell array of the plane PLN0, the lower page program for writing the data D(A, L1) to the memory cell array of the plane PLN1, the lower page program for writing the data D(A, L2) to the memory cell array of the plane PLN2, and the lower page program for writing the data D(A, L3) to the memory cell array of the plane PLN3.

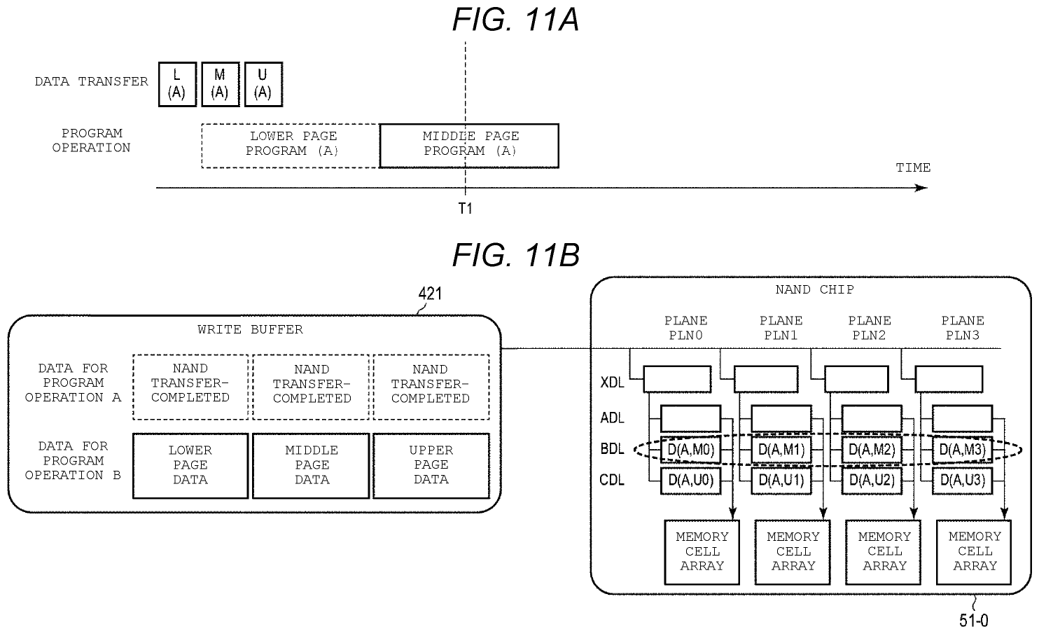

FIG. 11 is a diagram illustrating a state of the NAND chip 51-0 during execution of the middle page program of the program operation A.

As illustrated in FIG. 11A, at timing T1, the lower page program of the program operation A has already been completed. For this reason, as illustrated in FIG. 11B, the ADL of each plane PLN is released. The NAND chip 51-0 simultaneously executes the middle page program for writing the data D(A, M0) to the memory cell array of the plane PLN0, the middle page program for writing the data D(A, M1) to the memory cell array of the plane PLN1, the middle page program for writing the data D(A, M2) to the memory cell array of the plane PLN2, and the middle page program for writing the data D(A, M3) to the memory cell array of the plane PLN3.

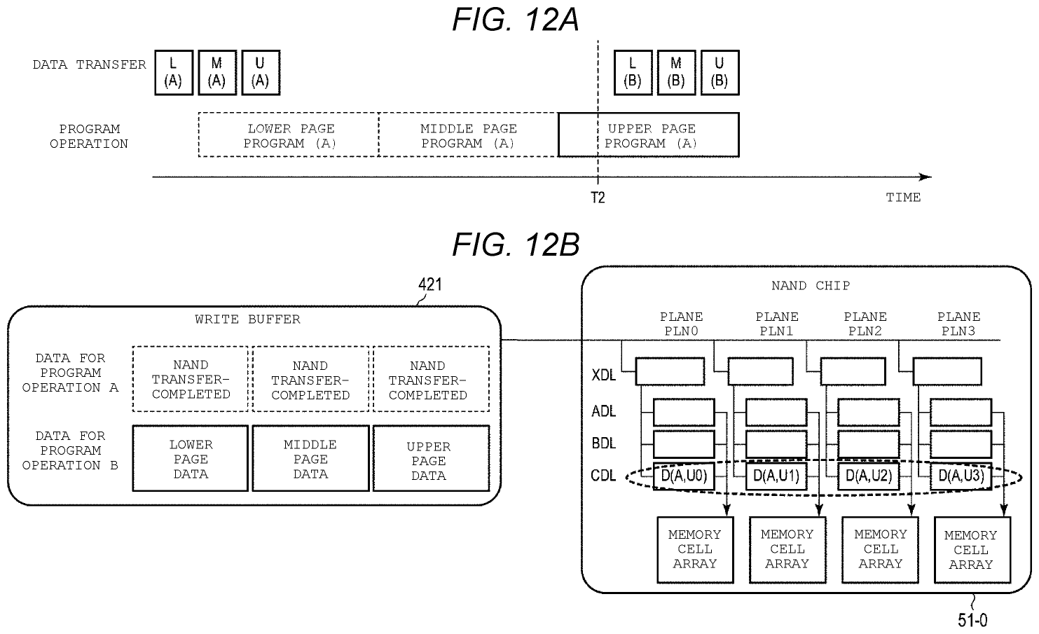

FIG. 12 is a diagram illustrating a state of the NAND chip 51-0 at the start of execution of the upper page program of the program operation A.

As illustrated in FIG. 12A, at timing T2, both the lower page program and the middle page program of the program operation A have already been completed. For this reason, as illustrated in FIG. 12B, the ADL and BDL of each plane PLN are released.

The NAND chip 51-0 simultaneously executes the upper page program for writing the data D(A, U0) to the memory cell array of the plane PLN0, the upper page program for writing the data D(A, U1) to the memory cell array of the plane PLN1, the upper page program for writing the data D(A, U2) to the memory cell array of the plane PLN2, and the upper page program for writing the data D(A, U3) to the memory cell array of the plane PLN3.

In each plane PLN, the ADL, the BDL, and the XDL are in an available state. For this reason, three pages of data can be transferred to each plane PLN.

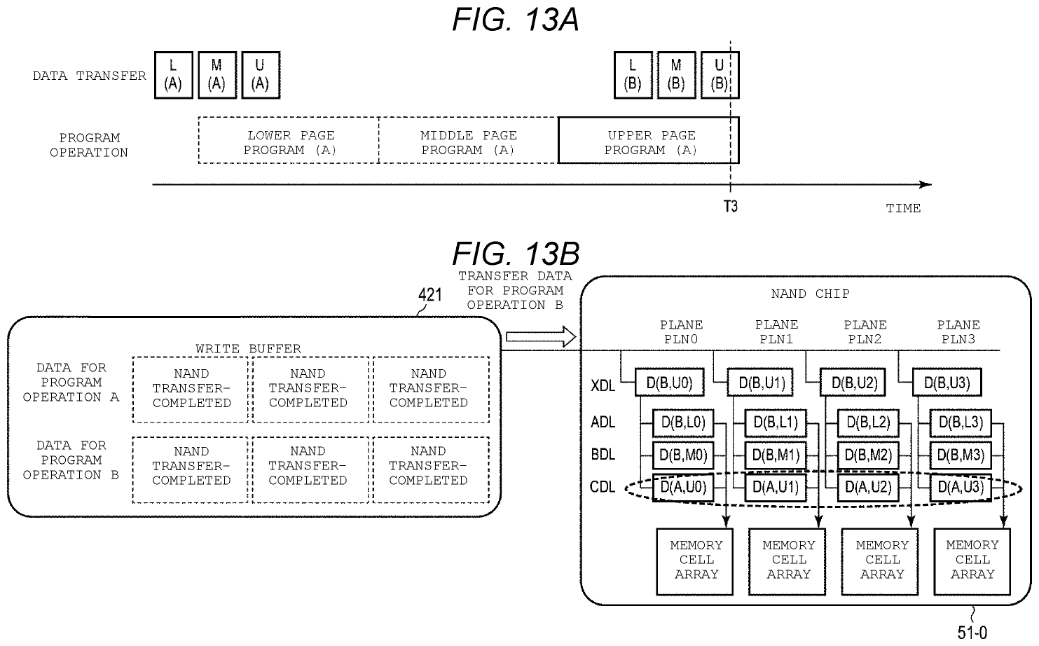

FIG. 13 is a diagram illustrating an operation of transferring data of the next program operation B to the NAND chip 51-0 during execution of the upper page program operation of the program operation A.

As illustrated in FIG. 13A, at timing T3, the transfer of the lower page data L(B) and middle page data M(B) for the program operation B to the NAND chip 51-0 has already been completed, and the transfer of the upper page data U(B) for the program operation B to the NAND chip 51-0 is being executed.

When the lower page data L(B) for the program operation B is transferred to the NAND chip 51-0, as illustrated in FIG. 13B, the data D(B, L0), the data D(B, L1), the data D(B, L2), and the data D(B, L3) included in the lower page data L(B) are stored in the ADL of the plane PLN0, the ADL of the plane PLN1, the ADL of the plane PLN2, and the ADL of the plane PLN3, respectively.

When the middle page data M(B) for the program operation B is transferred to the NAND chip 51-0, as illustrated in FIG. 13B, the data D(B, M0), the data D(B, M1), the data D(B, M2), and the data D(B, M3) included in the middle page data M(B) are stored in the BDL of the plane PLN0, the BDL of the plane PLN1, the BDL of the plane PLN2, and the BDL of the plane PLN3, respectively.

When the upper page data U(B) for the program operation B is transferred to the NAND chip 51-0, as illustrated in FIG. 13B, the data D(B, U0), the data D(B, U1), the data D(B, U2), and the data D(B, U3) included in the upper page data U(B) are stored in the XDL of the plane PLN0, the XDL of the plane PLN1, the XDL of the plane PLN2, and the XDL of the plane PLN3, respectively.

Thereafter, when the upper page program of the program operation A is completed, the lower page program of the program operation B is started. In addition, the data D(B, U0), the data D(B, U1), the data D(B, U2), and the data D(B, U3) are moved from the XDL to the CDL of the plane PLN0, from the XDL to the CDL of the plane PLN1, from the XDL to the CDL of the plane PLN2, and from the XDL to the CDL of the plane PLN3, respectively.

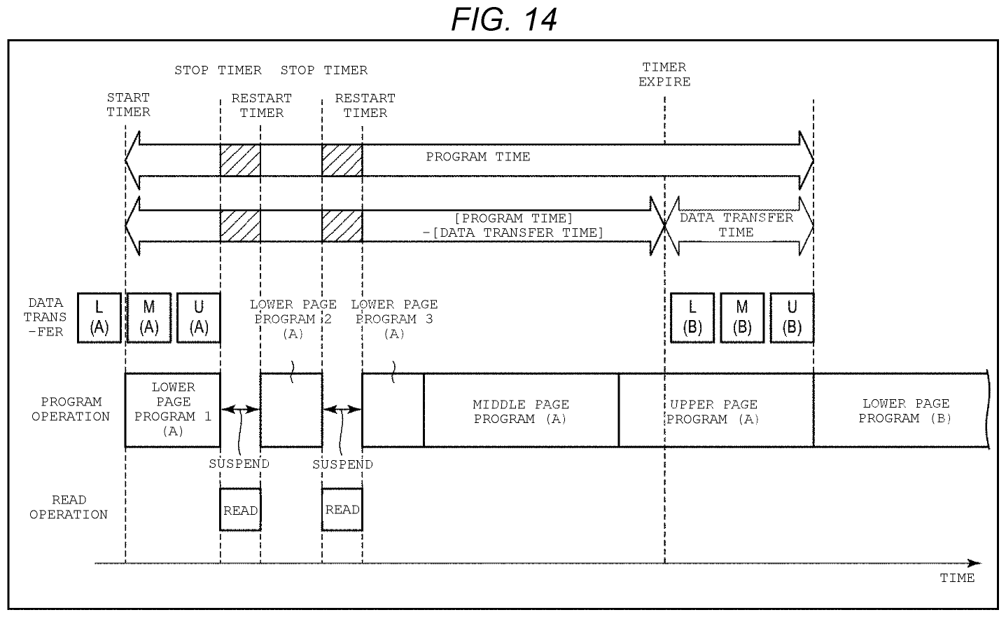

Next, control in a suspend process by the timer will be described. FIG. 14 is a timing chart illustrating an operation of stopping the timer operation while the program operation of the NAND chip 51 is suspended.

When a process is executed that causes the NAND chip 51 to suspend the program operation A and causes the NAND chip 51 to execute the read operation during suspension of the program operation A, an optimal timing for starting the transfer of the write data for the next program operation B is shifted to a time point later than the time point when the first time has elapsed from the start of the program operation A.

For this reason, in order to correct this shift, the NAND controller 461 stops the operation of the timer 4612 while the program operation A is suspended when causing the NAND chip 51 to suspend the program operation A and causing the NAND chip 51 to execute the read operation during suspension of the program operation A.

In FIG. 14, a case is illustrated in which the lower page program of the program operation A is suspended twice. In this case, when suspending the lower page program of the program operation A, the NAND controller 461 executes the operation of stopping the timer 4612, the operation of transmitting the suspend command to the NAND chip 51, and the operation of transmitting the read command sequence to the NAND chip 51. The suspend command is a command that instructs the NAND chip 51 to suspend the program operation. The read command sequence is a command for causing the NAND chip 51 to execute the read operation for reading data.

When the reading of data from the NAND chip 51 is completed, the NAND controller 461 executes an operation of restarting the timer 4612 and an operation of transmitting a resume command to the NAND chip 51. The resume command is a command that instructs the NAND chip 51 to resume the program operation.

In this manner, the NAND controller 461 stops the operation of the timer 4612 while the program operation A is suspended. Accordingly, the shift in the optimal timing for starting the transfer of the write data for the next program operation B can be corrected.

Next, several examples of a write process procedure will be described. In the following, a case will be assumed in which the NAND chip 51-0 is caused to execute the program operation A and the program operation B.

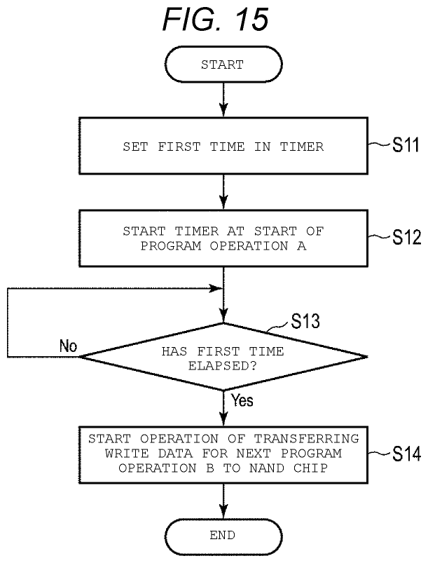

FIG. 15 is a flowchart illustrating a first example of the write process procedure executed in the SSD 3.

When causing the NAND chip 51-0 to execute the program operation A, the controller 4 sets the first time to the timer 4612-00 corresponding to the NAND chip 51-0 (S11).

The controller 4 causes the NAND chip 51-0 to start the program operation A. In this case, the controller 4 transmits the command sequence including the write data for the program operation A to the NAND chip 51-0. Then, at the start of the program operation A in the NAND chip 51-0, the controller 4 starts the timer 4612-00 (S12).

The controller 4 determines whether the first time has elapsed from the start of the program operation A based on the presence or absence of a timeout notification from the timer 4612-00 (S13).

When the first time has not elapsed from the start of the program operation A (No in S13), the controller 4 waits until the first time has elapsed from the start of the program operation A.

When the first time has elapsed from the start of the program operation A, that is, when the timeout notification from the timer 4612-00 is received (Yes in S13), the controller 4 starts the operation of transferring the write data for next program operation B to the NAND chip 51-0 (S14). In S14, the controller 4 starts the process of transmitting the command sequence including the write data for the next program operation B to the NAND chip 51-0, and thus, the operation of transferring the write data for the next program operation B to the NAND chip 51-0 is started.

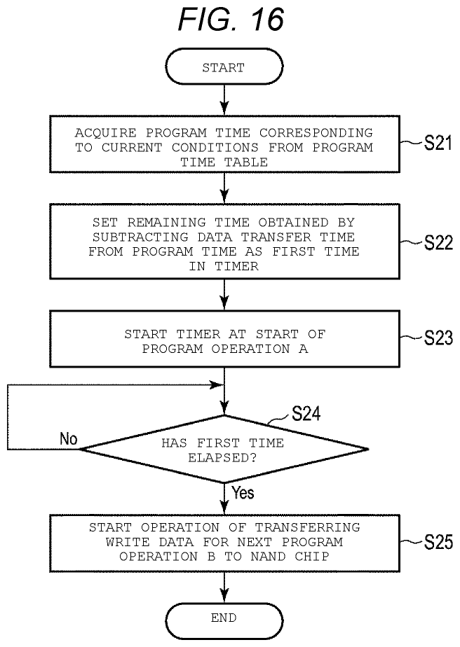

FIG. 16 is a flowchart illustrating a second example of the write process procedure executed in the SSD 3.

Herein, it is assumed that the controller 4 manages the program time table 62 and acquires the program time corresponding to the conditions of the program operation A to be executed from the program time table 62. It is noted that the processes from S23 to S25 in FIG. 16 are the same as the processes from S12 to S14 illustrated in FIG. 15, and thus, the description thereof will be simplified below.

Before causing the NAND chip 51-0 to execute the program operation A, the controller 4 acquires the program time corresponding to the current conditions (word line corresponding to the write target page, the number of program/erase cycles of the write target block, or the temperature of the NAND chip 51-0) related to the program operation A from the program time table 62 (S21).

The controller 4 sets the remaining time obtained by subtracting the data transfer time from the acquired program time as the first time in the timer 4612-00 corresponding to the NAND chip 51-0 (S22). The data transfer time is a time required to transfer the write data for the next program operation B to the NAND chip 51-0.

Then, after the first time set in the timer 4612-00 has elapsed from the start of the program operation A, the controller 4 starts the operation of transferring the write data for the next program operation B to the NAND chip 51-0 (S23 to S25).

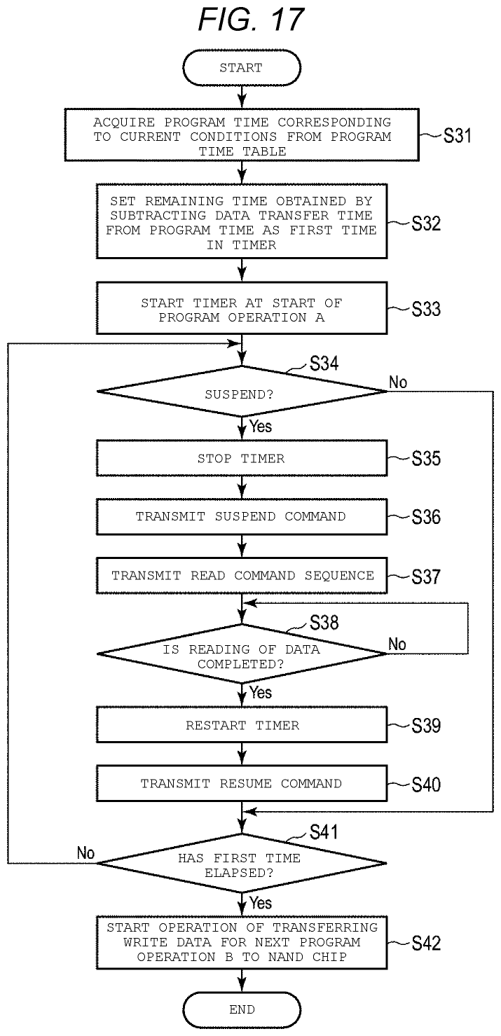

FIG. 17 is a flowchart illustrating a third example of the write process procedure executed in the SSD 3.

Herein, it is assumed that the NAND chip 51-0 is caused to suspend the program operation A and execute the read operation.

The processes from S31 to S33 in FIG. 17 are the same as the processes from S21 to S23 illustrated in FIG. 16, and thus, the description thereof will be omitted.

After starting the operation of the timer 4612-00 corresponding to the NAND chip 51-0, the controller 4 determines whether there is a need to suspend the program operation A being executed in the NAND chip 51-0 (S34). For example, during execution of the program operation A, when other data requested by the read command from the host 2 need to be read from the NAND chip 51-0, the controller 4 determines that there is a need to suspend the program operation A.

When the program operation A needs to be suspended (Yes in S34), the controller 4 stops the operation of the timer 4612-00 (S35). The controller 4 transmits the suspend command to the NAND chip 51-0 (S36), to cause the NAND chip 51-0 to suspend the program operation A. It is noted that the process of S35 and the process of S36 may be executed simultaneously. Alternatively, the process of S35 may be executed after the process of S36 is executed.

Then, the controller 4 transmits the read command sequence to the NAND chip 51-0, and thus, causing the NAND chip 51-0 to execute the read operation for reading data (S37).

The controller 4 determines whether the reading of data from the NAND chip 51-0 is completed (S38).

When the reading of data from the NAND chip 51-0 is not completed (No in S38), the controller 4 waits until the reading of data from the NAND chip 51-0 is completed.

When the reading of data from the NAND chip 51-0 is completed (Yes in S38), that is, when the reading of data from the memory cell array to the page buffer and the transfer of this data from the NAND chip 51-0 to the controller 4 are completed, the controller 4 restarts the timer 4612-00 (S39). The controller 4 transmits the resume command to the NAND chip 51-0 (S40), and thus, causing the NAND chip 51-0 to resume the program operation A. It is noted that the process of S39 and the process of S40 may be executed simultaneously. Alternatively, the process of S39 may be executed after the process of S40 is executed.

The controller 4 determines whether the first time has elapsed from the start of the program operation A based on the presence or absence of the timeout notification from the timer 4612-00 (S41).

When the first time has not elapsed from the start of the program operation (No in S41), the controller 4 executes the process of S34 again.

When there is no need to suspend the program operation A (No in S34), the controller 4 skips the processes of S35 to S40. Then, the controller 4 determines whether the first time has elapsed from the start of the program operation A (S41).

When the first time has elapsed from the start of the program operation A, that is, when the timeout notification from the timer 4612-00 is received (Yes in S41), the controller 4 starts the process of transmitting the command sequence including the write data for next program operation B to the NAND chip 51-0, and thus, the operation of transferring the write data for the next program operation B to the NAND chip 51-0 is started (S42).

As described above, according to this embodiment, the timing for transferring data for the next program operation to the flash memory 5 (NAND chip 51) is optimized during execution of the program operation in the flash memory 5 (NAND chip 51). This prevents the read latency from increasing and allows data to be efficiently written to the nonvolatile memory.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system comprising:
a nonvolatile memory including a memory cell array and a cache buffer, the cache buffer being configured to receive second data for a next program operation during execution of a program operation for writing first data to the memory cell array; and
a controller configured to control the nonvolatile memory, wherein the controller is configured to:
measure an elapsed time from a start of the program operation; and
start an operation of transferring the second data to the nonvolatile memory based on elapse of a first time from the start of the program operation, such that (i) transfer of the second data to the nonvolatile memory is completed during execution of the program operation, and (ii) the transfer of the second data to the nonvolatile memory is started after the elapse of the first time from the start of the program operation.

2. The memory system according to claim 1, wherein the first time is determined based on a remaining time obtained by subtracting (i) a time required to transfer the second data to the nonvolatile memory from (ii) a program time required for the program operation.

3. The memory system according to claim 2, wherein the controller is configured to:
manage information indicating a correspondence relationship between (i) each of conditions of the program operation that cause the program time to change and (ii) each of the program times required for the program operation; and
determine the program time corresponding to current conditions related to the program operation based on the information, before causing the nonvolatile memory to execute the program operation.

4. The memory system according to claim 3,
wherein the nonvolatile memory includes a plurality of nonvolatile memory chips,
wherein each of the plurality of nonvolatile memory chips includes a plurality of blocks, each block being a unit of erasing operation,
wherein each of the plurality of blocks includes a plurality of pages, each page corresponding to a plurality of word lines,
wherein each of the plurality of pages is a unit of each of the program operation and a read operation, and
wherein the controller is configured to determine the program time corresponding to the current conditions related to the program operation based on (i) the number of current program/erase cycles of a block on which the program operation is executed, (ii) current temperature of the nonvolatile memory chip on which the program operation is executed, or (iii) a word line corresponding to a page on which the program operation is executed.

5. The memory system according to claim 1, wherein the controller is configured to stop measuring the elapsed time while the program operation is suspended, when causing the nonvolatile memory to suspend the program operation and causing the nonvolatile memory to execute a read operation during suspension of the program operation.

6. The memory system according to claim 1,
wherein the nonvolatile memory is configured to store a plurality of bits of data per memory cell provided in the memory cell array, and
wherein the controller is configured to start the operation of transferring a plurality of pages of data for the next program operation, as the second data, to the nonvolatile memory based on the elapse of the first time from the start of the program operation during execution of the program operation.

7. The memory system according to claim 1, further comprising a write buffer having an area for temporarily storing data associated with a write command received from a host,
wherein the controller is configured to
release the area in which the data is stored in the write buffer based on completion of the transfer of data from the write buffer to the nonvolatile memory.

8. The memory system according to claim 1, wherein the nonvolatile memory includes a plurality of memory chips, and
the memory system further comprises a plurality of timers, each timer being configured to being measure the elapsed time from the start of the program operation in a corresponding memory chip.

9. The memory system according to claim 1, wherein the nonvolatile memory includes a NAND flash memory.

10. The memory system according to claim 1, wherein the controller is configured to perform various processes by executing a firmware, the various processes including the measuring the elapsed time and starting the operation of transferring the second data.

11. A control method of controlling a nonvolatile memory including a memory cell array and a cache buffer configured to receive second data for a next program operation during execution of a program operation for writing first data to the memory cell array, the method comprising:
measuring an elapsed time from start of the program operation; and
starting an operation of transferring the second data to the nonvolatile memory based on elapse of a first time from the start of the program operation, such that (i) transfer of the second data to the nonvolatile memory is completed during execution of the program operation and (ii) the transfer of the second data to the nonvolatile memory is started after the elapse of the first time from the start of the program operation.

12. The method according to claim 11, wherein the first time is determined based on a remaining time obtained by subtracting (i) a time required to transfer the second data to the nonvolatile memory from (ii) a program time required for the program operation.

13. The method according to claim 12, further comprising:
managing information indicating a correspondence relationship between (i) each of conditions of the program operation that cause the program time to change and (ii) each of the program times required for the program operation; and
determining the program time corresponding to current conditions related to the program operation based on the information, before causing the execution of the program operation.

14. The method according to claim 13,
wherein the nonvolatile memory includes a plurality of nonvolatile memory chips,
wherein each of the plurality of nonvolatile memory chips includes a plurality of blocks, each block being a unit of erasing operation,
wherein each of the plurality of blocks includes a plurality of pages, each page corresponding to a plurality of word lines,
wherein each of the plurality of pages is a unit of each of the program operation and a read operation, and
the method further comprising:
determining the program time corresponding to the current conditions related to the program operation based on (i) the number of current program/erase cycles of a block on which the program operation is executed, (ii) current temperature of the nonvolatile memory chip on which the program operation is executed, or (iii) a word line corresponding to a page on which the program operation is executed.

15. The method according to claim 11, further comprising:
stopping measuring the elapsed time while the program operation is suspended, when causing the nonvolatile memory to suspend the program operation and causing the nonvolatile memory to execute a read operation during suspension of the program operation.

16. The method according to claim 11,
wherein the nonvolatile memory is configured to store a plurality of bits of data per memory cell provided in the memory cell array, and the method further comprising:
starting the operation of transferring a plurality of pages of data for the next program operation, as the second data, to the nonvolatile memory based on the elapse of the first time from the start of the program operation during execution of the program operation.

17. The method according to claim 11, the nonvolatile memory further comprising a write buffer having an area for temporarily storing data associated with a write command received from a host,
the method further comprising:
releasing the area in which the data is stored in the write buffer based on completion of the transfer of data from the write buffer to the nonvolatile memory.

18. The method according to claim 11, wherein the nonvolatile memory includes a plurality of memory chips, and
the memory system further comprises a plurality of timers, each timer being configured to being measure the elapsed time from the start of the program operation in a corresponding memory chip.

19. The method according to claim 11, wherein the nonvolatile memory includes a NAND flash memory.

20. The method according to claim 11, further comprising:
performing various processes by executing a firmware, the various processes including the measuring the elapsed time and starting the operation of transferring the second data.
